(19) United States
(12) Patent Application Publication
(10) Pub. No.: US 2007/0121484 A1
(43) Pub. Date: May 31, 2007

(54) METHOD OF TRANSMITTING SIGNALS FOR INITIAL SYNCHRONIZATION IN A WIRELESS COMMUNICATION SYSTEM USING ORTHOGONAL FREQUENCY DIVISION MULTIPLEXING (OFDM) OR OFDM ACCESS (OFDMA) SCHEME

(75) Inventors: Hak Seong Kim, Seoul (KR); Bong Hoe Kim, Ansan-si (KR); Joon Kui Ahn, Seoul (KR); Dong Youn Seo, Seoul (KR); Dong Wook Roh, Seoul (KR); Jung Hoon Lee, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG Electronics Inc.

(21) Appl. No.: 11/557,048

(22) Filed: Nov. 6, 2006

(30) Foreign Application Priority Data
Nov. 4, 2005 (KR) 10-2005-0105527

(51) Int. Cl. H04J 11/00

(52) U.S. Cl. 370/208; 370/350; 370/503

(57) ABSTRACT

A method of receiving at least one synchronization signal from at least one base station (BS) in a wireless communication system using an Orthogonal Frequency Division Multiplexing (OFDM) or an OFDM Access (OFDMA) scheme is disclosed. More specifically, the method includes receiving the at least one synchronization signal transmitted from a first cell using a different resource than a resource of a second cell corresponding to the resource of the first cell, wherein the resource is defined by at least one of time period and subcarriers.

This application claims the benefit of Korean Application No. P10-2005-105527, filed on Nov. 4, 2005, which is hereby incorporated by reference.

### BACKGROUND OF THE INVENTION

1. Field of the Invention

The present invention relates to a method of transmitting signals, and more particularly, to a method of transmitting signals for initial synchronization in a wireless communication system using orthogonal frequency division multiplexing or orthogonal frequency division multiplexing access scheme.

2. Discussion of the Related Art

Researches related to an orthogonal frequency division multiplexing (OFDM) scheme or an orthogonal frequency division multiplexing access (OFDMA) scheme are widely talking place. In the OFDM technique, a plurality of mutually exclusive subcarriers is used to increase efficiency. Moreover, the process of modulating/demodulating the plurality of mutually exclusive subcarriers at the transmitting/receiving ends is similar to performing inverse discrete Fourier transform (IDFT) and discrete Fourier transform (DFT), respectively. As such, the subcarriers can be constructed using inverse fast Fourier transform (IFFT) and fast Fourier transform (FFT).

The principle of the OFDM scheme is where the high speed data stream are divided into a plurality of low speed data streams. The plurality of low speed data streams are simultaneously transmitted using a plurality of subcarriers. Consequently, relative dispersion in the time domain is reduced according to multi-path delay spread by increasing symbol duration. In the OFDM scheme, data transmission can be measured in units of transmit symbols.

Further, in the OFDM scheme, a modulator/demodulator is not necessary for each subcarrier since modulating/demodulating can be processed collectively by using the DFT. At the transmitting end, the modulator/demodulator can convert data stream(s) inputted serially into data streams arranged in parallel by using the IFT. Here, the converted data streams correspond to a number of subcarriers. In order to process high speed data, the IFFT is used. The inverse Fourier transformed is then converted into serial data which is then transmitted after frequency conversion. At the receiving end, the processed data is decoded using the reverse process.

As a multiple access scheme for transmitting downlink data, the OFDMA scheme is used in a cellular mobile communication system. A mobile terminal in the cellular mobile communication system makes an initial synchronization to establish downlink connection prior to data transmission. The initial synchronization process includes processes related to time synchronization, frequency synchronization, and cell identification,

In the conventional wireless communication system using OFDMA scheme, a synchronization channel for establishing downlink synchronization and a pilot channel downlink channel estimation from a mobile station (MS) are transmitted together. However, in addition to the pilot channel taking up time-frequency resources, the downlink synchronization channel also demands time-frequency resources, and therefore, channel resources can be wasted.

Further, in the conventional wireless communication system using OFDMA scheme, a frequency bandwidth used by a cell or a base station (BS) is same as a frequency bandwidth used by a MS. In the current and/or improved wireless communication system using OFDMA scheme, the bandwidth used by the cell/BS may be different than the bandwidth used by the MS. In other words, further considerations are necessary to configure a wireless communication system where the downlink initial synchronization of the MS is smoothly established even when the bandwidth size used by the BS is different than that of the MS.

### SUMMARY OF THE INVENTION

Accordingly, the present invention is directed to a method of transmitting signals for initial synchronization in a wireless communication system using orthogonal frequency division multiplexing or orthogonal frequency division multiplexing access that substantially obviates one or more problems due to limitations and disadvantages of the related art.

An object of the present invention is to provide a method of receiving at least one synchronization signal from at least one base station (BS) in a wireless communication system using an Orthogonal Frequency Division Multiplexing (OFDM) or an OFDM Access (OFDMA) scheme.

Another object of the present invention is to provide a method of reducing interference between neighbor cells when transmitting at least one synchronization signal from at least one base station (BS) in a wireless communication system using an Orthogonal Frequency Division Multiplexing (OFDM) or an OFDM Access (OFDMA) scheme.

In a further object of the present invention is to provide a wireless communication system using an Orthogonal Frequency Division Multiplexing (OFDM) or an OFDM Access (OFDMA) scheme for reducing interference between neighbor cells when receiving at least one synchronization signal from at least one base station (BS).

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of receiving at least one synchronization signal from at least one base station (BS) in a wireless communication system using an Orthogonal Frequency Division Multiplexing (OFDM) or an OFDM Access (OFDMA) scheme includes receiving the at least one synchronization signal transmitted from a first cell using a different resource than a resource of a second cell corresponding to the resource of the first cell, wherein the resource is defined by at least one of time period and subcarriers.

In another aspect of the present invention, a method of reducing interference between neighbor cells when transmitting at least one synchronization signal from at least one base station (BS) in a wireless communication system using an Orthogonal Frequency Division Multiplexing (OFDM) or an OFDM Access (OFDMA) scheme includes transmitting the at least one synchronization signal from a first cell using a different resource than a resource of a second cell corresponding to the resource of the first cell, wherein the resource is defined by at least one of time period and subcarriers.

In a further aspect of the present invention, a wireless communication system using an Orthogonal Frequency Division Multiplexing (OFDM) or an OFDM Access (OFDMA) scheme for reducing interference between neighbor cells when receiving at least one synchronization signal from at least one base station (BS) includes at least one antenna for receiving at least one synchronization signal transmitted from a first cell using a different resource than a resource of a second cell corresponding to the resource of the first cell, wherein the resource is defined by at least one of time period, subcarriers, and code.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a downlink frame structure according to an embodiment of the present invention;

FIG. 2 illustrates a downlink frame structure according to another embodiment of the present invention; and

FIG. 3 is a block diagram a receiving end of a wireless communication system which illustrates establishing initial synchronization according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The wireless communication system using the OFDM/OFDMA scheme can be explained with respect to two sides. One side, referred to as a network, includes at least one cell or BS, and the other side comprises a plurality of MSs to the plurality of MSs.

The network uses the BS or the cell to provide various types of services through a wireless interface. Generally, the network can be comprised of a BS having at least one cell, a controller for controlling the BS, and a switchboard for exchanging signal with another switchboard in the same system or with a switchboard of another wired/wireless system.

Further, the plurality of MSs can receive various types of services provided by the network by communicating with the BS of the cell to which the MS is located in. In order to receive various types of services from the BS/network, the MS first needs to establish connection or synchronization with the network. For this, the network transmits the synchronization signal to establish initial synchronization with the MS. The synchronization signal can be included in a downlink frame transmitted to the MS, and by using the synchronization signal included in the downlink frame, the MS can establish initial synchronization.

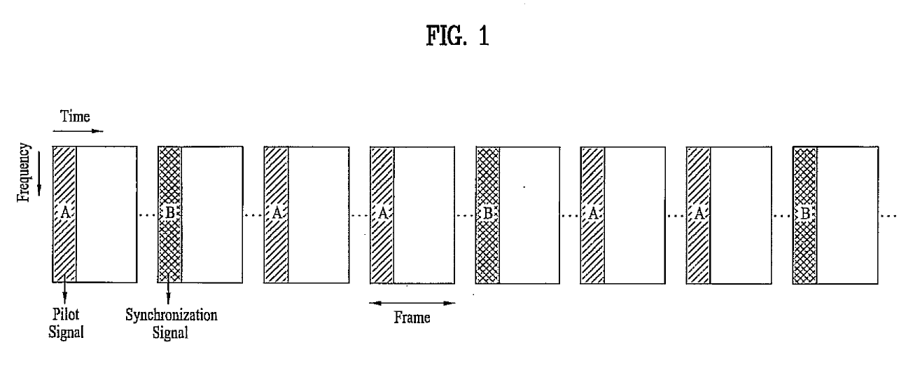

FIG. 1 illustrates a downlink frame structure according to an embodiment of the present invention. In FIG. 1, a pilot signal and/or a synchronization signal are allocated or included in the downlink frame. That is, the pilot signal and/or the synchronization signal is/are assigned or allocated to time-frequency domain of each downlink frame, represented by a section labeled “A”. As illustrated in FIG. 1, each downlink frame has section “A” allocated thereto in the time-frequency domain for transmitting the pilot signal and/or the synchronization signal. Here, the synchronization signals transmitted from one cell can use different time and/or frequency domain than the synchronization signal transmitted from another cell. Further, the pilot signals can be used for downlink channel estimation at the MS, and the synchronization signals can be used for establishing initial synchronization. Preferably, the downlink frame including the synchronization signal is periodically transmitted.

These synchronization signals can be transmitted from a cell (or a BS). In the wireless system employing the OFDM/OFDMA scheme, the synchronization signals transmitted maintain orthogonality between each other. In other words, the synchronization signal transmitted from one cell may be orthogonal to the synchronization signal transmitted from another cell. That is, the one cell uses different time-frequency resources than the time-frequency resources of another cell. Here, the frequency can also be referred to as subcarriers.

The allocation of synchronization signal and/or the pilot signal as described in FIG. 1 is merely an example. As such, the allocation of the signals to the downlink frame is not limited to the example of FIG. 1, and the synchronization/pilot signals can be allocated to other sections/parts of the downlink frame.

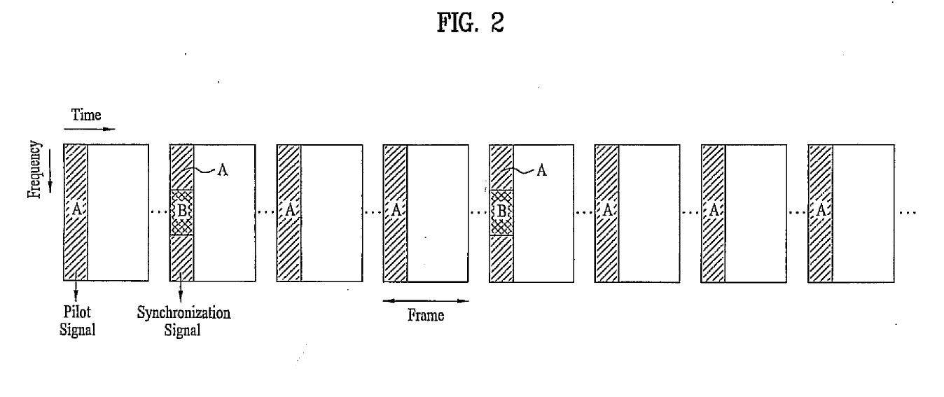

FIG. 2 illustrates a downlink frame structure according to another embodiment of the present invention. Comparing FIG. 2 to FIG. 1, the function of FIG. 2 is similar to that of FIG. 1 in that the synchronization signal and the pilot signal are allocated to the time-frequency domain. More specifically, section “A” of the downlink frame represents pilot signals as illustrated in FIG. 1. In FIG. 2, the synchronization signal is allocated or included only in a specified section or portion of the downlink frame, indicated as section “B”. As shown in FIG. 2, unlike FIG. 1, the synchronization signal occupies a specified portion of the downlink frame in the time-frequency domain and can co-exist with section “A” in the same downlink frame.

By sharing the time-frequency domain or put differently, by including the synchronization signal with the pilot signal in the time-frequency domain of the same downlink frame, as illustrated in FIG. 2, the time and frequency resources can be used more efficiently. In other words, compared to occupying the entire time-frequency resources of each frame for transmitting either the pilot signal or the synchronization signal, as illustrated in FIG. 1, the sharing of the time-frequency domain of FIG. 2 can be used to improve efficiency of the time and frequency resources.

As discussed, the pilot signal can be used for downlink channel estimation at the MS, and the synchronization signal can be used for establishing initial synchronization. Again, it is preferable that the downlink frame including the synchronization signal is periodically transmitted.

Further in FIG. 2, the system can host a plurality of MSs, each of which supports different frequency bandwidths. That is, the system can support scalable bandwidth which means that the system can have MSs which communicate on different bandwidths. In order for each MS in the system to establish initial synchronization with the network, the synchronization signal can be transmitted on a frequency bandwidth which corresponds to the smallest frequency bandwidth used by any one of the MS in the system. In other words, the synchronization signal can be transmitted on a frequency bandwidth within a minimum cell bandwidth. Alternatively, the synchronization signal can be transmitted on a frequency bandwidth which corresponds to a specified size bandwidth (e.g., average size).

In FIG. 2, the frequency bandwith occupied by section “B” equivalent to a section corresponding to the smallest frequency bandwidth. Further, it is possible to allocate downlink channel estimation or cell identification pilot signal to the section of the time-frequency domain section “A” other than section “B”.

In the embodiments described above, preferably, the pilot signals used for channel estimation are different between neighboring cells. With respect to the signal pattern(s) of the synchronization signals, the following signal patterns (or codes) can be implemented.

First, the signal pattern (or code) of the synchronization signal can be configured to be the same signal which can apply to all cells in the system. With this, when the MS initiates synchronization with the system, the MS does not need to consider other patterns or codes but only one signal pattern. Since this one signal is used to search for downlink synchronization signal, the downlink time-frequency synchronization can take place more quickly.

In using the same signal across the cells in the system, inter-cell interference can also be reduced by preventing the synchronization signal from being transmitted at the same time between neighboring cells. In so doing, the MS can use the synchronization signal for functions such as channel estimation as used the pilot signal.

Second, at least two signal patterns (or codes) can be used as the signal patterns of the synchronization signal. That is, the signal patterns or codes of the synchronization signals in a cell can be different. Moreover, a plurality of cell identification pilot signals or scrambling code pattern(s) can be allocated or mapped to each signal pattern. Here, a number of the synchronization signal patterns is preferably less than a number of cell identification pilot signal patterns or a number of scrambling code patterns. Further, the MS knows the signal patterns of all synchronization signal and the cell identification pilot signal patterns or scrambling code patterns mapped to the signal patterns of each synchronization signal.

If at least two synchronization signals, each having different signal patterns, are used in the system, then the synchronization signals having different signal patterns are transmitted between neighboring cells at a certain given point in time. In other words, looking at an arbitrary point in time, the synchronization signals having different signal patterns are simultaneously transmitted between neighboring cells. As a result, interference between synchronization signals can be reduced, and the synchronization signal can be used by the MS for channel estimation in the same capacity as pilot signals. If the synchronization signals having different signal patterns (or codes) use different subcarriers or the same subcarrier on the frequency domain, the correlation between the synchronization signals may be small. Moreover, orthogonal signal patterns may be used to reduce and/or prevent interference. Moreover, the subcarriers of different cells (e.g., cell #1 and cell #2) can be allocated differently so that each synchronization signal can be distinguishable.

Further, there can be a plurality of synchronization signals in each cell. Again, as discussed, the synchronization signals in each cell can be distinguished based on time, frequency (e.g., subcarriers), and/or code (or signal patterns). For example, assume there are two signals in a first cell and a second cell, respectively. The first cell and the second cell each include a first synchronization signal and a second synchronization signal. The first synchronization signal of the first cell can be identified by a signal pattern or code (e.g., Walsh code 1) which is different from the signal pattern or code (e.g., Walsh code 3) of the second synchronization of the second cell. Moreover, the second synchronization of the first cell can be identified by a time and/or frequency resource which is different from the time and/or frequency resource of the second synchronization of the second cell. By using different codes and/or time/frequency resources, the synchronization signals can be distinguished between cells.

In addition, the plurality of synchronization signals, such as the first synchronization signal and the second synchronization signal, can be used for various purposes including acquiring cell specific information of each cell (e.g., cell identification) or establishing synchronization with the network.

In the discussion above, the signal patterns associated with the synchronization signal or the pilot signal can be different. In other words, the code patterns for the synchronization signal or the pilot signal can be configured differently. Alternatively, even if the code patterns are the same for the synchronization signal and/or the pilot signal, the time-frequency domain can be made different for the signals so that each synchronization signal or the pilot signal can be distinguished. Moreover, the signal patterns or codes for the synchronization signal of one cell can be different from the signal patterns or codes for the synchronization signal of another cell so as to distinguish synchronization signals between/among cells using different signal patterns/codes. Further, the number of signal patterns/codes for the synchronization signal of one cell can be different from the number of signal patterns/codes for the synchronization signal of another cell. Further, the signal patterns/codes can be same for the synchronization signals in the same cell.

In other words, the pilot signals and/or synchronization signals can be transmitted to establish synchronization. To this end, the signals can be allocated based on time, different frequencies (or subcarriers), and/or different codes (e.g., orthogonal or quasi-orthogonal).

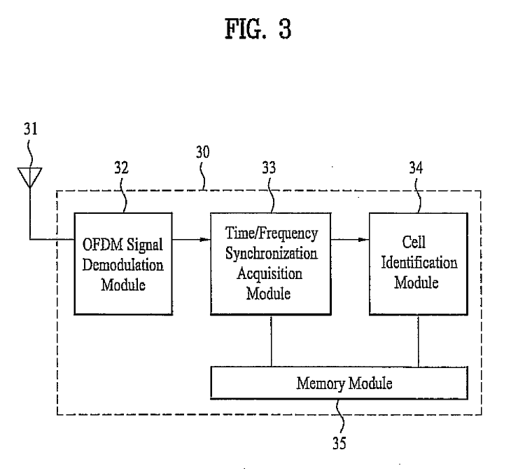

FIG. 3 is a block diagram a receiving end of a wireless communication system which illustrates establishing initial synchronization according to an embodiment of the present invention. Referring to FIG. 3, a MS 30 of the wireless communication system includes an antenna 31, an OFDM signal demodulation module 32, a time/frequency synchronization module 33, a cell identification module 34, a memory module 35. The antenna 31 receives a downlink frame which is configured as illustrated in FIGS. 1 and 2. The OFDM signal demodulation module 32 demodulates the downlink frame received via the antenna 31 using a general scheme. The demodulation process is well known to the one of ordinary skilled in the art.

Further, the time/frequency synchronization module 33 retrieves or restores the synchronization signal included in the downlink frame and establishing time and frequency synchronization. Since the MS knows the transmission period during which the downlink frame containing the synchronization signal is transmitted, the MS can determine or identify whether the synchronization signal is included in the received downlink frame based the transmission period.

The time and frequency synchronization can vary based on the number of synchronization signal patterns used by the entire system. If the system uses only one synchronization signal pattern or code, the MS can achieve time and frequency synchronization by comparing the synchronization signal pattern known to the MS with the received synchronization signal to determine the correlation between the two.

If the system uses a plurality of synchronization signal patterns or codes and the cell identification pilot signal patterns or scrambling code patterns are mapped to each synchronization signal patterns, the MS can determine the correlation between each synchronization signal pattern and the received synchronization signal by comparing each synchronization signal pattern or code with the received synchronization signal. Here, by using the best correlation result, the MS can then acquire time synchronization and frequency synchronization as well as corresponding synchronization signal patterns.

The cell identification module 34 performs cell identification process according to the time synchronization and the frequency synchronization as well as corresponding synchronization signal patterns (or codes) acquired from the time/frequency synchronization module 33. If the system uses a plurality of synchronization signal patterns and a plurality of cell identification pilot signal patterns or scrambling code patterns mapped to each synchronization pattern, the MS identifies a cell by searching the plurality of cell identification pilot signal patterns or the scrambling code patterns which are mapped to the synchronization signal pattern (or codes) acquired from the time synchronization and frequency synchronization process.

The memory module 35 stores information related to one synchronization signal pattern used by the system, a plurality of synchronization signal patterns, and/or the cell identification pilot signal patterns or the scrambling code patterns mapped to each synchronization signal pattern. The time/frequency synchronization module 33 and the cell identification module 34 can use, if necessary, the information stored in the memory 35 to perform corresponding process.

Further, the time/frequency synchronization module 33 and the cell identification module 34 can be combined, in terms of hardware or software, to perform the process.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of receiving at least one synchronization signal from at least one base station (BS) in a wireless communication system using an Orthogonal Frequency Division Multiplexing (OFDM) or an OFDM Access (OFDMA) scheme, the method comprising receiving the at least one synchronization signal transmitted from a first cell using a different resource than a resource of a second cell corresponding to the resource of the first cell, wherein the resource is defined by at least one of time period and subcarriers.

2. The method of claim 1, wherein the resource is further defined by a code resource.

3. The method of claim 2, wherein the code resources are same for at least two synchronization signals in a same cell.

4. The method of claim 2, wherein the code resources for at least two synchronization signal of the first cell is different from the code resources for at least two synchronization signal of the second cell.

5. The method of claim 2, wherein the code resources for at least two synchronization signals in the cell is different from the code resources for at least two synchronization signal of other neighboring cells.

6. The method of claim 2, wherein a number of code resources for the synchronization signal of the first cell is different from a number of the code resources for the synchronization signal of the second cell.

7. The method of claim 6, wherein a number of code resources associated with the synchronization signal is smaller than a number of codes associated with pilot signals or scrambling codes.

8. The method of claim 1, further comprising receiving another synchronization signal using a different code resource of the first cell than a code resource of the second cell.

9. The method of claim 1, further comprising receiving at least one pilot signal from the first cell using the different resource than the resource of the pilot signal of the second cell.

10. The method of claim 9, wherein the pilot signal is used for downlink channel estimation.

11. The method of claim 1, wherein the synchronization signal is used for establishing initial synchronization.

12. The method of claim 1, wherein the synchronization signal is used for identifying a cell.

13. The method of claim 1, wherein the synchronization signals are received periodically.

14. The method of claim 1, wherein the subcarriers are received via a frequency bandwidth having a smallest size.

15. The method of claim 1, wherein the subcarriers are received via a frequency bandwidth having an average size.

16. The method of claim 1, wherein the wireless communication system supports scalable bandwidths in which a plurality of mobile stations can communicate on different bandwidths.

17. The method of claim 1, wherein the synchronization signal is allocated to a smallest frequency bandwidth and a pilot signal is allocated to remaining parts of the frequency bandwidth.

18. The method of claim 1, wherein the synchronization signal is allocated to a mid-size frequency bandwidth and a pilot signal is allocated to remaining parts of the frequency bandwidth.

19. A method of reducing interference between neighbor cells when transmitting at least one synchronization signal from at least one base station (BS) in a wireless communication system using an Orthogonal Frequency Division Multiplexing (OFDM) or an OFDM Access (OFDMA) scheme, the method comprising transmitting the at least one synchronization signal from a first cell using a different resource than a resource of a second cell corresponding to the resource of the first cell, wherein the resource is defined by at least one of time period and subcarriers.

20. The method of claim 19, wherein the resource is further defined by a code resource.

21. The method of claim 19, further comprising transmitting another synchronization signal using a different code resource of the first cell than a code resource of the second cell.

22. The method of claim 19, further comprising transmitting at least one pilot signal from the first cell using the different resource than the resource of the second cell.

23. The method of claim 19, wherein the synchronization signals are transmitted periodically.

24. The method of claim 19, wherein the wireless communication system supports scalable bandwidths in which a plurality of mobile stations can communicate on different bandwidths.

25. The method of claim 19, wherein the synchronization signal is allocated to a smallest frequency bandwidth and a pilot signal is allocated to remaining parts of the frequency bandwidth.

26. The method of claim 19, wherein the resource is further defined by a code resource.

27. A wireless communication system using an Orthogonal Frequency Division Multiplexing (OFDM) or an OFDM Access (OFDMA) scheme for reducing interference between neighbor cells when receiving at least one synchronization signal from at least one base station (BS), the system comprising at least one antenna for receiving at least one synchronization signal transmitted from a first cell using a different resource than a resource of a second cell corresponding to the resource of the first cell, wherein the resource is defined by at least one of time period, subcarriers, and code.

28. The system of claim 27, further comprising:
a OFDM signal demodulation module for demodulating the at least one synchronization signal;
a resource synchronization module for retrieving the at least one synchronization signal and establishing the time period synchronization;
a cell identification module for performing cell identification process; and
a memory module for storing at least one synchronization code.
